(19) United States
(12) Patent Application Publication
(10) Pub. No.: US 2022/0130295 A1
(43) Pub. Date: Apr. 28, 2022

(54) DISPLAY SYSTEM AND CONTROL METHOD FOR DISPLAY SYSTEM

(71) Applicant: SEIKO EPSON CORPORATION, Tokyo (JP)

(72) Inventor: Shigehito ITO, Sapporo-shi Chuo-ku (JP)

(21) Appl. No.: 17/507,916

(22) Filed: Oct. 22, 2021

(30) Foreign Application Priority Data
Oct. 23, 2020 (JP) 2020-178014

(51) Int. Cl. G09G 3/00; G09G 3/20

(52) U.S. Cl. CPC G09G 3/001; G09G 3/2003; G09G 2370/022; G09G 2354/00; G09G 2360/144

(57) ABSTRACT

In a display system including a first device and a second device. The first device includes a first display device displaying a first image; a sensor measuring an illuminance of a periphery of the first device; and a first control circuit determining setting information based on the illuminance. The second device includes a second control circuit generating a second image having a color scheme determined based on the setting information; and a second display device displaying the second image.

The present application is based on, and claims priority from JP Application Serial Number 2020-178014, Oct. 23, 2020, the disclosure of which is hereby incorporated by reference herein in its entirety.

### BACKGROUND

### 1. Technical Field

The present disclosure relates to a display system and a control method for a display system.

### 2. Related Art

JP-A-2000-298246 discloses a head-mounted display apparatus in which an indoor use mode and an outdoor use mode are selectable and which automatically sets screen brightness, contrast, edge enhancement or the like according to the amount of external light.

When another apparatus coupled to a display apparatus is used, the another device needs to be operated separately from the setting of the display apparatus in order to change the setting of a display device of the another device.

### SUMMARY

An aspect is directed to a display system including a first device and a second device. The first device includes a first display device displaying a first image, a sensor measuring an illuminance of a periphery of the first device, and a first control circuit determining setting information based on the illuminance. The second device includes a second control circuit generating a second image having a color scheme determined based on the setting information, and a second display device displaying the second image.

Another aspect is directed to a control method for a display system including a first device and a second device. The method includes in the first device, causing a first display device to display a first image, causing a sensor to measure an illuminance of a periphery of the first device, and causing a first control circuit to determine setting information based on the illuminance, and in the second device, causing a second control circuit to generate a second image having a color scheme determined based on the setting information; and causing a second display device to display the second image.

### BRIEF DESCRIPTION OF THE DRAWINGS

FIG. 1 is a schematic view explaining a display system according to a first embodiment.

FIG. 2 is a block diagram explaining the display system according to the first embodiment.

FIG. 3 is a sequence diagram explaining a control method for the display system according to the first embodiment.

FIG. 4 explains an example of a second image having a first color scheme.

FIG. 5 explains an example of a second image having a second color scheme.

FIG. 6 is a schematic view explaining a display system according to a second embodiment.

FIG. 7 is a sequence diagram explaining a control method for the display system according to the second embodiment.

FIG. 8 is a sequence diagram explaining a control method for the display system according to a modification example of the second embodiment.

### DESCRIPTION OF EXEMPLARY EMBODIMENTS

First and second embodiments of the present disclosure will now be described with reference to the drawings. In the drawings, the same or similar elements are denoted by the same or similar reference signs and the description thereof is not repeated in some cases. The embodiments described below illustrate a system for embodying a technical idea of the present disclosure, and a device and method used for this system. The technical idea of the present disclosure is not limited to the type and configuration of each device, the network topology, the series of processes and the like described below.

### First Embodiment

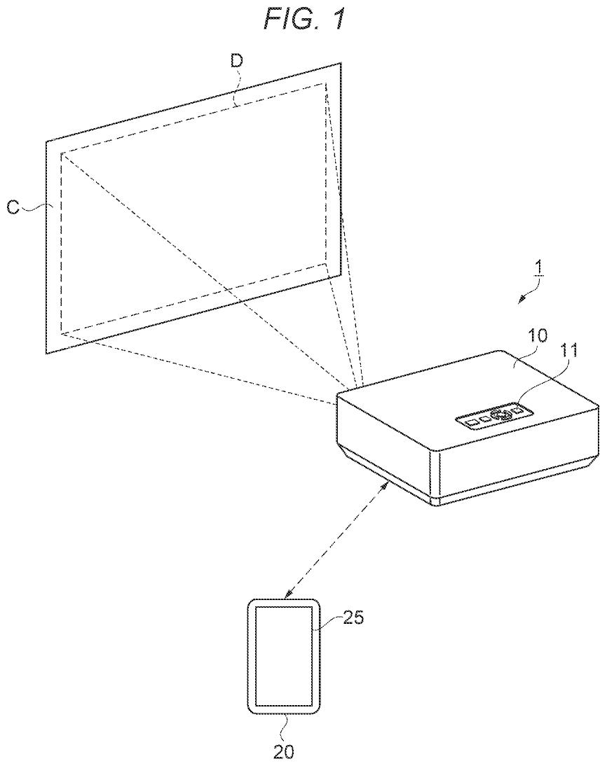

As shown in FIG. 1, a display system 1 according to the first embodiment has a first device 10 and a second device 20 communicatively coupled to the first device. The first device 10 is, for example, a projector which projects light onto a screen C such as a rolling screen and thus displays an image D thereon. The second device 20 is, for example, a mobile computer such as a tablet terminal, a smartphone or a laptop computer.

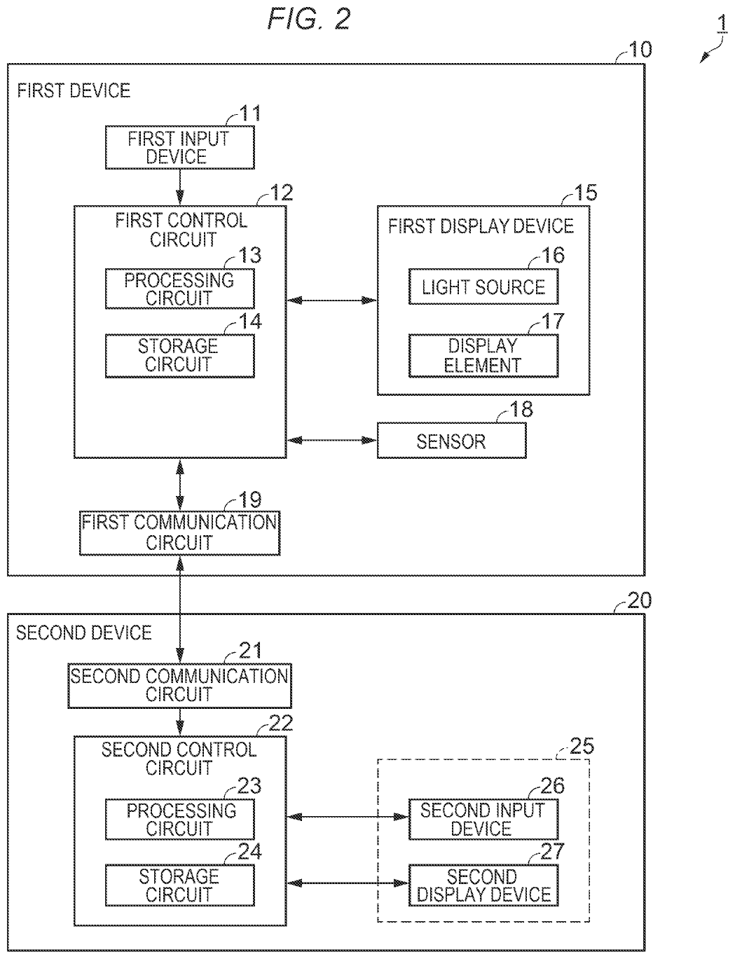

As shown in FIG. 2, the first device 10 has a first input device 11, a first control circuit 12, a first display device 15, a sensor 18, and a first communication circuit 19. The first input device 11 accepts an operation by a user and outputs a signal corresponding to the operation by the user to the first control circuit 12. As the first input device 11, various input devices such as a push button, a touch sensor, and a pointing device can be employed.

The first display device 15 has, for example, a light source 16, a display element 17 such as a liquid crystal panel having a plurality of pixels, and an optical system, not illustrated, including a lens and a mirror or the like. The display element 17 modulates light emitted from the light source 16, according to a drive signal representing a first image generated by a processing circuit 13. The first display device 15, under the control of the processing circuit 13, projects the light that has gone through the display element 17 onto the screen C, using the optical system, and thus displays the first image as the image D on the screen C.

The sensor 18 is an illuminance sensor measuring the illuminance of the periphery of the first device 10. The sensor 18 is arranged, for example, on the inner side of a casing of the first device 10 and faces outside the casing via a light-transmissive window forming the surface of the casing. The sensor 18 may also detect the color of the periphery of the first device 10, using a color filter, in addition to detecting the illuminance of the periphery of the first device 10.

The first control circuit 12 has the processing circuit 13 and a storage circuit 14. The processing circuit 13 forms a processing device of a computer performing computational processing that is necessary for the operation of the first device 10. The processing circuit 13 executes, for example, a control program stored in the storage circuit 14 and thus implements various functions of the first device 10 described in the embodiment. As a processing device forming at least a part of the processing circuit 13, various computational logic circuits such as a central processing unit (CPU), a digital signal processor (DSP), a programmable logic device (PLD), and an application-specific integrated circuit (ASIC) can be employed. The processing circuit 13 may be formed of an integrated single piece of hardware or a plurality of separate pieces of hardware.

The storage circuit 14 is a computer-readable storage medium storing a control program representing a series of processes that is necessary for the operation of the first device 10, and various data. As the storage circuit 14, for example, a semiconductor memory can be employed. The storage circuit 14 is not limited to a non-volatile auxiliary storage device and can include a volatile main storage device such as a register or a cache memory. At least a part of the storage circuit 14 may be formed by a part of the processing circuit 13. The storage circuit 14 may be formed of an integrated single piece of hardware or a plurality of separate pieces of hardware.

The processing circuit 13 acquires the illuminance measured by the sensor 18, from the sensor 18, in response to a request signal transmitted from the second device 20 and requesting setting information. The processing circuit 13 determines setting information, based on the illuminance acquired from the sensor 18. The setting information is information used to determine a color scheme of a second image generated at the second device 20. The setting information may be information that is determined, based on the illuminance, from among a plurality of options prepared in advance, or may be information representing the illuminance. The setting information may also be information representing the color scheme of the second image that is determined, based on the illuminance.

The first communication circuit 19 transmits the setting information generated by the processing circuit 13 to the second device 20 in response to a request signal transmitted from the second device 20. The first communication circuit 19, for example, under the control of the processing circuit 13, establishes a communication link with the second device 20 and is thus communicatively coupled to the second device 20. The first communication circuit 19 can include, for example, an antenna transmitting and receiving a wireless signal, a receptacle in which a plug of a communication cable is inserted, a circuit processing a signal transmitted via the communication link, or the like. The communication link may be wired, wireless, or a combination of wired and wireless links. That is, the first communication circuit 19 may be directly coupled to the second device 20 or may be indirectly coupled to the second device 20 via another communication device.

The first communication circuit 19 may receive multimedia data including image data from the second device 20 and may receive multimedia data from another playback device. The image data included in the multimedia data is, for example, processed by the first control circuit 12 and thus displayed as the first image by the first display device 15. The first image may be computer graphics generated by the first control circuit 12. The first device 10 may also have an output interface that plays back audio data included in the multimedia data.

The second device 20 has a second communication circuit 21, a second control circuit 22, a second input device 26, and a second display device 27. The second communication circuit 21, under the control of the second control circuit 22, transmits a request signal requesting setting information to the first device 10. The second communication circuit 21 receives setting information transmitted from the first device 10 in response to the request signal.

The second communication circuit 21, under the control of the second control circuit 22, establishes a communication link with the first device 10 and is thus communicatively coupled to the first device 10. The second communication circuit 21 can include, for example, an antenna transmitting and receiving a wireless signal, a receptacle in which a plug of a communication cable is inserted, a circuit processing a signal transmitted via the communication link, or the like.

The second control circuit 22 has a processing circuit 23 formed of a processing device such as a CPU, and a storage circuit 24 formed of a semiconductor memory or the like. The processing circuit 23 forms a processing device of a computer performing computational processing that is necessary for the operation of the second device 20. The processing circuit 23 executes, for example, a control program stored in the storage circuit 24 and thus implements various functions of the second device 20 described in the embodiment. The processing circuit 23 may be formed of an integrated single piece of hardware or a plurality of separate pieces of hardware.

The storage circuit 24 is a computer-readable storage medium storing a control program representing a series of processes that is necessary for the operation of the second device 20, and various data. The storage circuit 24 is not limited to a non-volatile auxiliary storage device and can include a volatile main storage device such as a register or a cache memory. That is, at least a part of the storage circuit 24 may be formed by a part of the processing circuit 23. The storage circuit 24 may be formed of an integrated single piece of hardware or a plurality of separate pieces of hardware.

The processing circuit 23 acquires, for example, the setting information received by the second communication circuit 21 from the first device 10 and determines a color scheme of the second image, based on the setting information. The processing circuit 23 generates the second image having the color scheme that is determined based on the setting information.

The second input device 26 is, for example, a pointing device that accepts an operation by the user and outputs a signal corresponding to the operation by the user to the second control circuit 22. The second display device 27 displays the second image under the control of the processing circuit 23. The second display device 27 is, for example, a flat panel display such as a liquid crystal display or an organic light-emitting diode display.

The second image functions, for example, as a user interface used to determine control information for controlling the first display device 15. The control information can include, for example, the first image displayed by the first display device 15, the image quality of the first image including brightness, contrast, edge enhancement or the like, focal length, projection settings such as a projection range, and the like. The second image may be provided to the first device 10 and thus displayed on the first display device 15 simultaneously with the second display device 27. That is, the first image can include the second image.

The second input device 26 and the second display device 27 may be integrated together to form a touch panel display 25. The second input device 26 and the second display device 27 may be separate pieces of hardware. In this case, the second input device 26 may be another input device such as a keyboard or a switch.

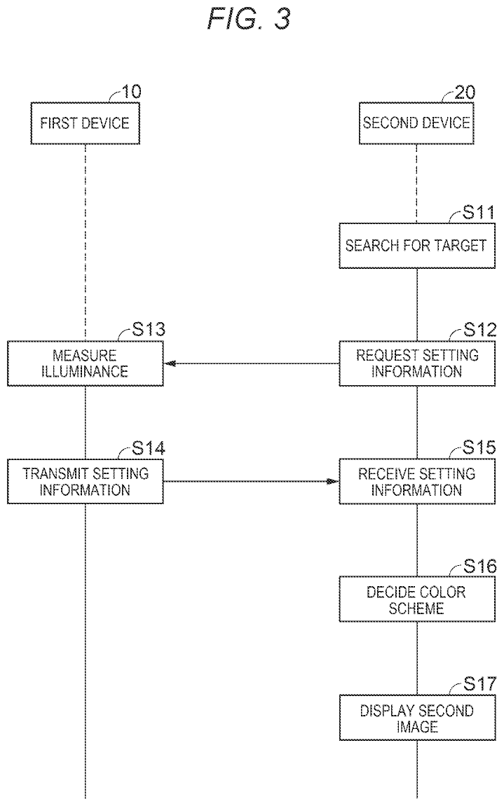

Referring to the sequence diagram of FIG. 3, an example of the operations of the first device 10 and the second device 20 will now be described as a control method for the display system 1 according to the first embodiment. The series of processes shown in FIG. 3 is started, for example, in response to an operation by the user to the second input device 26 that gives an instruction to start the control program.

In step S11, the processing circuit 23 searches for the first device 10 that is a target to which a request signal is to be transmitted, in the network to which the second communication circuit 21 is coupled. When the result of the search includes the first device 10, the second communication circuit 21 in step S12 transmits a request signal requesting setting information to the first device 10 under the control of the processing circuit 23. When the result of the search does not include the first device 10, the processing proceeds to step S17.

In step S13, the first communication circuit 19 receives the request signal transmitted from the second device 20. The processing circuit 13 acquires a signal representing an illuminance measured by the sensor 18 in response to the request signal. In step S14, the processing circuit 13 determines setting information based on the illuminance measured in step S13 and transmits the setting information to the second device 20 via the first communication circuit 19.

In step S15, the second communication circuit 21 receives the setting information transmitted from the first device 10. In step S16, the processing circuit 23 determines a color scheme of a second image based on the setting information received in step S15 and generates a signal representing the second image.

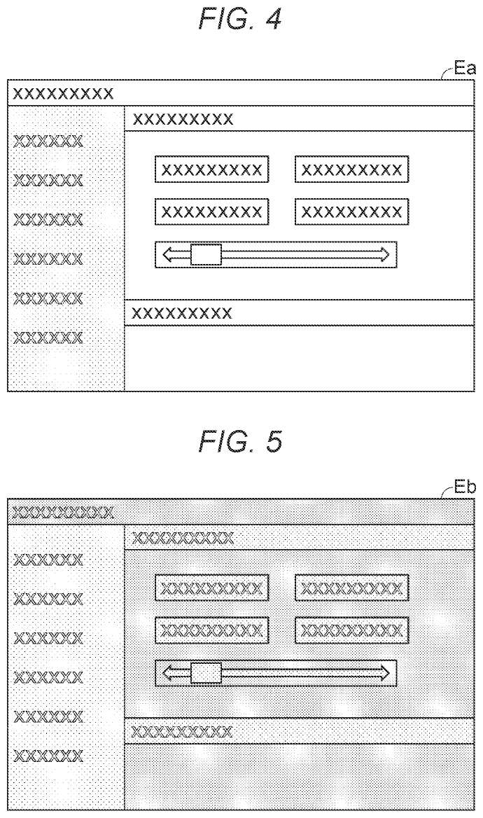

For example, when acquiring setting information indicating that the illuminance measured by the sensor 18 is equal to or higher than a threshold, the processing circuit 23 generates an image Ea having a first color scheme as the second image, as shown in FIG. 4. Meanwhile, when acquiring setting information indicating that the illuminance measured by the sensor 18 is lower than the threshold, the processing circuit 23 generates an image Eb having a second color scheme that is darker as a whole than the first color scheme, as the second image, as shown in FIG. 5. The first color scheme includes, for example, a combination of a bright background color and a dark character color. The second color scheme includes, for example, a combination of a dark background color and a bright character color. In this way, the first color scheme and the second color scheme can be complementary with each other.

In step S17, the second display device 27, under the control of the processing circuit 23, displays the second image generated in step S16 as an image corresponding to the startup of the control program. When the result of the search in step S11 does not include the first device 10, the second image having a color scheme of an initial setting may be displayed. The color scheme of the initial setting can be any color scheme selected from a group of color schemes including the first color scheme or the second color scheme.

As described above, in the display system 1, the color scheme of the second image displayed by the second device 20 is determined according to the illuminance of the periphery of the first device 10, for example, regardless of the setting or the like of the operating system of the second device 20. In this way, the color scheme of the second image is determined without having to perform a dedicated operation to the second device 20. Therefore, even when the second device 20 is operated in the periphery of the first device 10, for example, when control information for controlling the first display device 15 is determined using the second image, the second device 20 can display the second image having a proper color scheme. Thus, the operability of operating the second image in the periphery of the first device 10 can be improved. Also, when the periphery of the first device 10 is dark, for example, when the first device 10 projects the first image, the image Eb having the second color scheme is displayed as the second image. Thus, the discomfort of the user due to dazzling can be reduced.

### Second Embodiment

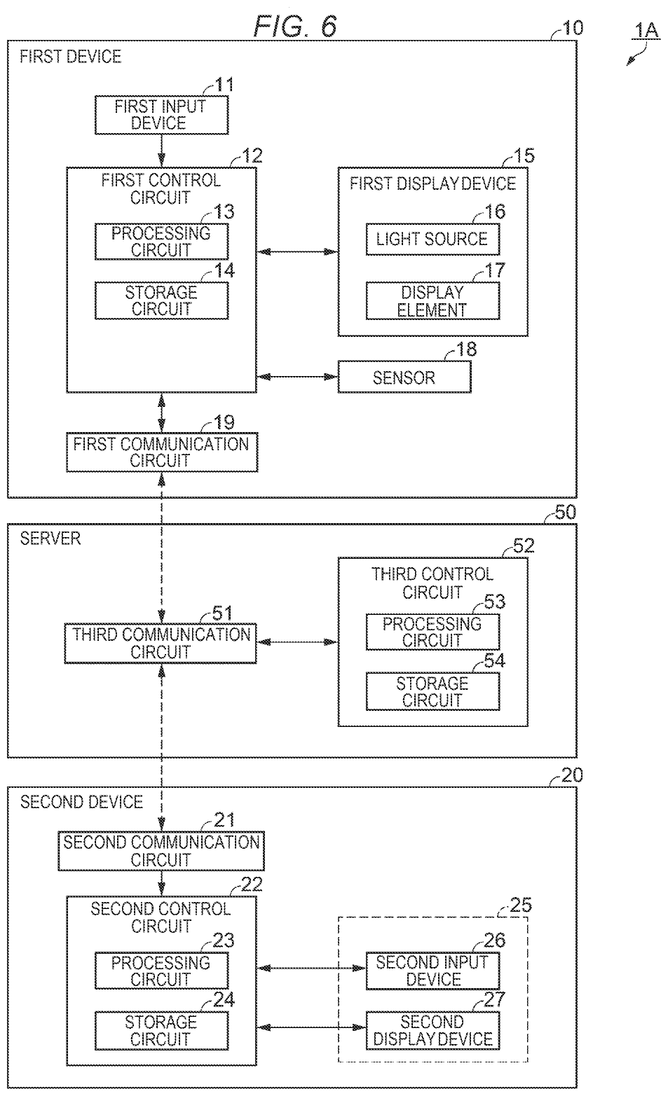

As shown in FIG. 6, a display system 1A according to the second embodiment differs from the first embodiment in further including a server 50 that is a web server. Configurations, operations, and effects that are not described in the second embodiment are similar to those in the first embodiment and therefore the description thereof is omitted.

The server 50 has a third communication circuit 51 and a third control circuit 52. The third communication circuit 51, under the control of the third control circuit 52, establishes a communication link with each of the first device 10 and the second device 20 and is thus communicatively coupled to each of the first device 10 and the second device 20. The third communication circuit 51 is coupled to each of the first device 10 and the second device 20, for example, via a network such as a local area network or the internet.

The third control circuit 52 has a processing circuit 53 and a storage circuit 54. The processing circuit 53 forms a processing device of a computer performing computational processing that is necessary for the operation of the server 50. The processing circuit 53 executes, for example, a control program stored in the storage circuit 54 and thus implements various functions of the server 50 described in the embodiment. The storage circuit 54 is a computer-readable storage medium storing a control program representing a series of processes that is necessary for the operation of the server 50, and various data. The specific hardware configurations of the processing circuit 53 and the storage circuit 54 can be similar to those of the processing circuit 13 and the storage circuit 14.

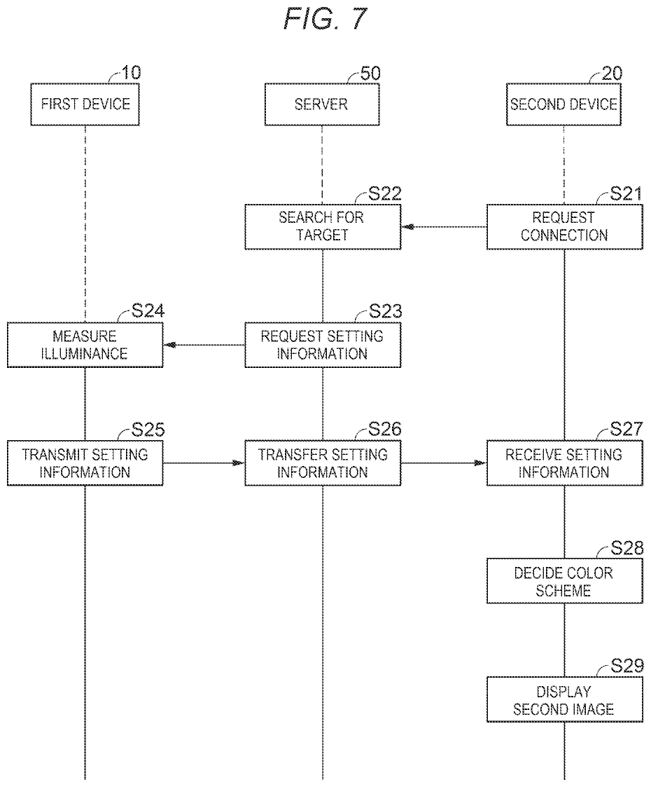

Referring to the sequence diagram of FIG. 7, an example of the operations of the first device 10, the second device 20, and the server 50 will now be described as a control method for the display system 1A according to the second embodiment. The series of processes shown in FIG. 7 is started, for example, in response to the second device 20 accessing the server 50 by a web browser installed in the second device 20.

In step S21, the processing circuit 23 requests connection to the server 50 via the third communication circuit 51. In step S22, the processing circuit 53 permits connection with the second device 20 in response to the request and searches for the first device 10 that is a target to which a request signal is to be transmitted. When the result of the search includes the first device 10, the third communication circuit 51 in step S23 transmits a request signal requesting setting information to the first device 10 under the control of the processing circuit 53. When the result of the search does not include the first device 10, the third communication circuit 51, under the control of the processing circuit 53, transmits information indicating that the result of the search does not include the first device 10 to the second device 20 and shifts the processing to step S29.

In step S24, the first communication circuit 19 receives the request signal transmitted from the server 50. The processing circuit 13 acquires a signal representing an illuminance measured by the sensor 18 in response to the request signal. In step S25, the processing circuit 13 determines setting information based on the illuminance measured in step S24. The first communication circuit 19 transmits the determined setting information to the server 50 under the control of the processing circuit 13. In step S26, the third communication circuit 51, under the control of the processing circuit 53, transfers the setting information transmitted thereto from the first device 10 to the second device 20.

In step S27, the second communication circuit 21 receives the setting information transferred from the server 50. In step S28, the processing circuit 23 determines a color scheme of a second image based on the setting information received in step S27 and generates a signal representing the second image. In step S29, the second display device 27, under the control of the processing circuit 23, displays the second image generated in step S28. When the result of the search in step S22 does not include the first device 10, the second image having a color scheme of an initial setting may be displayed.

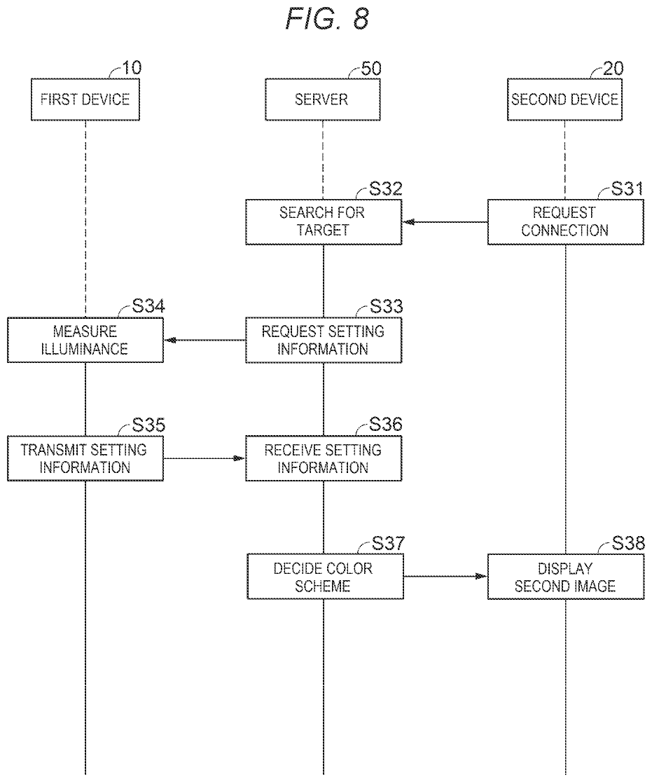

Referring to the sequence diagram of FIG. 8, a control method for the display system 1A according to a modification example of the second embodiment will now be described. Of the series of processes shown in FIG. 8, the processes of steps S31 to S35 are substantially similar to the processes of steps S21 to S25 in FIG. 7 and therefore the description thereof will not be repeated.

In step S36, the third communication circuit 51, under the control of the processing circuit 53, receives the setting information transmitted from the first device 10. In step S37, the processing circuit 53 determines a color scheme of a second image based on the setting information received in step S36 and generates image information used to generate the second image. The third communication circuit 51, under the control of the processing circuit 53, transmits the image information used to generate the second image to the second device 20.

In step S38, the processing circuit 23 generates the second image based on the image information generated in step S37. The second display device 27 displays the generated second image under the control of the processing circuit 23. When the result of the search in step S32 does not include the first device 10, the second image having a color scheme of an initial setting may be displayed.

### Other Embodiments

While the embodiments have been described above, the present disclosure is not limited to these embodiments. The configuration of each part may be replaced by any configuration having a similar function. Also, any configuration may be omitted from or added to each embodiment within the technical scope of the present disclosure. Based on such replacements, omissions and additions, various alternative embodiments are obvious to a person skilled in the art.

For example, in the first and second embodiments, the first device 10 is not limited to a projector and may be other devices such as a flat panel display device or a mobile computer. The first device 10 may successively transmit the setting information according to the illuminance successively measured by the sensor 18. Alternatively, the first device 10 may generate the setting information in response to a change in the illuminance in relation to a threshold as a reference value. Also, while two types of color schemes, that is, the first color scheme and the second color scheme, are described as the color scheme of the second image, three or more types of color schemes may be prepared as the color scheme of the second image, or the second image may have a brightness that linearly changes according to the illuminance. Moreover, the illuminance measured by the sensor 18 may be corrected according to the brightness of the image projected by the first display device 15.

The present disclosure also includes various other embodiments such as applying the foregoing configurations to each other. The technical scope of the present disclosure is defined only by the technical features according to the appended claims that are appropriate based on the foregoing description.

What is claimed is:

1. A display system comprising,
a first device including:
a first display device displaying a first image,
a sensor measuring an illuminance of a periphery of the first device, and
a first control circuit determining setting information based on the illuminance, and
a second device including:
a second control circuit generating a second image having a color scheme determined based on the setting information, and
a second display device displaying the second image.

2. The display system according to claim 1, wherein the first device further includes a first communication circuit transmitting the setting information to the second device,
the second device further includes a second communication circuit receiving the setting information, and
the second control circuit determines the color scheme of the second image based on the setting information.

3. The display system according to claim 1, further comprising:
a web server, wherein
the first device further includes a first communication circuit transmitting the setting information to the server,
the server includes a third control circuit determining the color scheme of the second image based on the setting information and generating image information used to generate the second image, and
the second control circuit generates the second image based on the image information.

4. The display system according to claim 1, wherein
the second image functions as a user interface used to determine control information controlling the first display device.

5. The display system according to claim 1, wherein
the second image has a first color scheme when the illuminance is equal to or higher than a threshold, and the second image has a second color scheme that is darker than the first color scheme when the illuminance is lower than the threshold.

6. The display system according to claim 5, wherein
the first color scheme and the second color scheme are complementary with each other.

7. The display system according to claim 1, wherein
the first image includes the second image.

8. The display system according to claim 1, wherein
the first device is a projector, and
the second device is a mobile computer.

9. A control method for a display system comprising:
displaying a first image by a first device,
measuring an illuminance of a periphery of the first device by a sensor of the first device, and
determining, by the first device, setting information based on the illuminance,
generating, by a second device, a second image having a color scheme determined based on the setting information, and
displaying the second image by the second device.
